(19) United States
(12) Patent Application Publication
(10) Pub. No.: US 2025/0022010 A1
(43) Pub. Date: Jan. 16, 2025

(54) ADVERTISEMENT DELIVERY METHOD AND DEVICE

(71) Applicant: Groundhog Inc., Taipei City (TW)

(72) Inventor: Szu Yen Chen, Taipei City (TW)

(73) Assignee: Groundhog Inc., Taipei City (TW)

(21) Appl. No.: 18/451,107

(22) Filed: Aug. 17, 2023

(30) Foreign Application Priority Data
Jul. 13, 2023 (TW) 112126109

(51) Int. Cl. G06Q 30/0251

(52) U.S. Cl. CPC G06Q 30/0271; G06Q 30/0254

(57) ABSTRACT

An advertisement delivery method and device are provided. The method includes: obtaining advertisement information and target audience of a specific product; determining multiple advertisement attributes and determining multiple input combinations accordingly; and generating multiple corresponding first advertisement creatives based on the multiple input combinations and delivering the multiple first advertisement creatives to the target audience.

### CROSS-REFERENCE TO RELATED APPLICATION

This application claims the priority benefit of Taiwan application serial no. 112126109, filed on Jul. 13, 2023. The entirety of the above-mentioned patent application is hereby incorporated by reference herein and made a part of this specification.

### BACKGROUND

### Technical Field

The disclosure relates to a technology for providing advertisements, and in particular, to a method and device for delivering advertisements.

### Description of Related Art

In the prior art, it has become an essential means of marketing for various product manufacturers to attract customers to buy the product manufacturer's own products through the advertisement creatives delivered on the Internet. However, since different audiences have different preferences for advertisement creatives, how to deliver an advertisement creative corresponding to the audience's preference is an important issue for those skilled in the art.

### SUMMARY

The disclosure provides an advertisement delivery method and advertisement delivery device, which may be used to solve the above technical problems.

An embodiment of the disclosure provides an advertisement delivery method adapted to an advertisement delivery device including the following steps. Advertisement information and target audience of a specific product are received. Multiple advertisement attributes are determined and multiple input combinations are determined accordingly. Each input combination includes one of the multiple advertisement attributes, the advertisement information, and the target audience. Multiple corresponding first advertisement creatives are generated based on the multiple input combinations and the multiple first advertisement creatives are delivered to the target audience.

An embodiment of the disclosure provides an advertisement delivery device, including a storage circuit and a processor. The storage circuit stores a program code. The processor is coupled to the storage circuit and accesses the program code to: obtain advertisement information and target audience of a specific product; determine multiple advertisement attributes and determine multiple input combinations accordingly, in which each input combination includes one of the multiple advertisement attributes, the advertisement information, and the target audience; and generate multiple corresponding first advertisement creatives based on the multiple input combinations and deliver the multiple first advertisement creatives to the target audience.

### BRIEF DESCRIPTION OF THE DRAWINGS

FIG. 1 is a schematic diagram of an advertisement delivery device according to an embodiment of the disclosure.

FIG. 2 is a flow diagram of an advertisement delivery method according to an embodiment of the disclosure.

### DESCRIPTION OF THE EMBODIMENTS

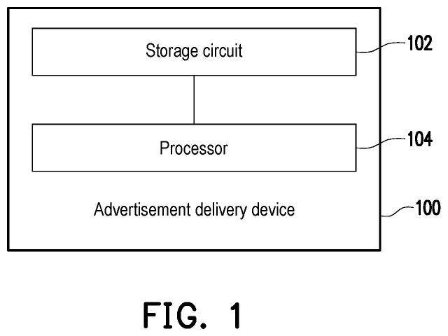

Please refer to FIG. 1. FIG. 1 is a schematic diagram of an advertisement delivery device according to an embodiment of the disclosure. In different embodiments, an advertisement delivery device 100 may be implemented as various smart devices and/or computer devices, but is not limited thereto.

In FIG. 1, an advertisement delivery device 100 includes a storage circuit 102 and a processor 104

The storage circuit 102 is, for example, any form of fixed or moveable random access memory (RAM), a read-only memory (ROM), a flash memory, a hard disc, other similar devices, or a combination of thereof which may be used to record multiple program codes or modules.

The processor 104 is coupled to the storage circuit 102 and may be a general purpose processor, a special purpose processor, a conventional processor, a digital signal processor, multiple microprocessors, one or more microprocessors combined with a digital signal processor core, a controller, a microcontroller, an application specific integrated circuit (ASIC), a field programmable gate array circuit (FPGA), any other kinds of integrated circuits, a state machine, an advanced RISC Machine (ARM) based processor, and the like.

In the embodiment of the disclosure, the processor 104 may access the modules and program codes recorded in the storage circuit 102 to implement the advertisement delivery method proposed by the disclosure. The details are described below.

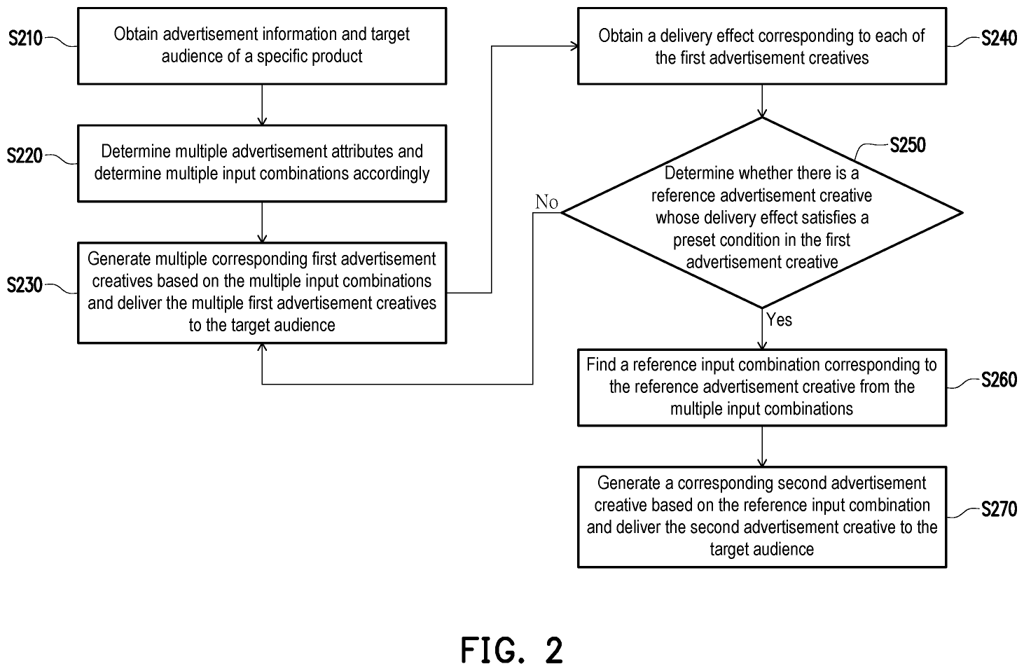

Please refer to FIG. 2. FIG. 2 is a flow diagram of an advertisement delivery method according to an embodiment of the disclosure. The method of the embodiment may be executed by the advertisement delivery device 100 of FIG. 1, and the details of each step in FIG. 2 will be described below with reference to the components shown in FIG. 1.

First, in step S210, the processor 104 obtains the advertisement information and the target audience of the specific product. In some embodiments, the advertisement information may include, for example, at least one of the advertiser name, the product name, and the product picture of the specific product to be advertised, but is not limited thereto. For ease of understanding, it is assumed below that the advertisement information of the specific product includes an advertiser name A, a product name B, and a product image C, but is not limited thereto.

In an embodiment, the target audience is, for example, a group of people belonging to a certain age group, having a certain interest, having a certain occupation, having a certain orientation, and/or having a certain preference, such as women aged 25-30, Engineers aged 40-50, men who like sports, women who like movies, but is not limited thereto. For ease of understanding, it is assumed below that the target audience acquired by the processor 104 may be called a target audience D, but is not limited thereto.

In step S220, the processor 104 determines the multiple advertisement attributes and determines the multiple input combinations accordingly. Each input combination includes one of the above-mentioned advertisement attributes, the advertisement information, and the target audience D.

In an embodiment of the disclosure, the multiple advertisement attributes may be used, for example, to set the tone for advertisement creatives later generated. For example, if a certain advertisement attribute is determined to be lively, then the advertisement creative generated accordingly may also have attributes and/or properties that tend to be lively. For another example, assuming that the advertisement attribute is determined to be calm, the advertisement creative generated accordingly may also have attributes and/or properties that tend to be calm, but is not limited thereto.

In the embodiment of the disclosure, the processor 104 may, for example, determine K advertisement attributes (K is a positive integer) in step S220, which may be called advertisement attributes E1 to EK respectively, but is not limited thereto.

Afterwards, the processor 104 may, for example, determine the multiple input combinations accordingly. In an embodiment, the multiple input combinations may correspond, for example, one-to-one to the multiple advertisement attributes. In this case, for example, the processor 104 may generate K input combinations, and each input combination may include one of the advertisement attributes E1 to EK, the advertisement information (such as the advertiser name A, the product name B, and the product image C), and the target audience D.

In an embodiment, the k-th (k is an index) input combination in the K input combinations may include, for example, the k-th advertisement attribute in the advertisement attributes E1 to EK, the advertiser name A, the product name B, the product image C, and the target audience D.

For example, the 1st input combination in the K input combinations may include the advertisement attribute E1, the advertiser name A, the product name B, the product image C, and the target audience D. For another example, the 2nd input combination in the K input combinations may include the advertisement attribute E2, the advertiser name A, the product name B, the product image C, and the target audience D. For still another example, the 3rd input combination in the K input combinations may include the advertisement attribute E3, the advertiser name A, the product name B, the product image C, and the target audience D. The contents of the other input combinations may be deduced according to the above description and will not be repeated here.

Next, in step S230, the processor 104 generates the multiple corresponding first advertisement creatives based on the multiple input combinations and delivers the multiple first advertisement creatives to the target audience D.

In an embodiment of the disclosure, the multiple input combinations may correspond one-to-one to the multiple first advertisement creatives. That is, when the number of the multiple input combinations is assumed to be K, the number of the multiple first advertisement creatives may also be K. Such an assumption will be used as an example for illustration in the following embodiments, but is used as an example only and is not intended to limit the possible implementations of the disclosure. In other embodiments, an input combination may also be used to generate multiple advertisement creatives, but is not limited thereto.

In an embodiment, the processor 104 may generate multiple (for example, K) first prompt languages corresponding to the K input combinations and individually input the first prompt languages into a first generative artificial intelligence model. In different embodiments, the first generative artificial intelligence model may be implemented by selecting different models according to the needs of designers, such as Midjourney, ChatGPT, but is not limited thereto. In an embodiment, the first generative artificial intelligence model may generate the first advertisement creatives respectively corresponding to the K input combinations in response to the multiple first prompt languages.

In an embodiment of the disclosure, the processor 104 may generate a corresponding first prompt language Pk based on the k-th input combination (which includes, for example, the advertisement attribute Ek, the advertiser name A, the product name B, the product image C, and the target audience D) and input the first prompt language Pk into the first generative artificial intelligence model. In this case, for example, the first generative artificial intelligence model may correspondingly generate the k-th first advertisement creative in the multiple first advertisement creatives, and the k-th first advertisement creative may have corresponding features/attributes of the k-th advertisement attribute.

For example, the processor 104 may generate the corresponding first prompt P1 based on the 1st input combination (which includes, for example, the advertisement attribute E1, the advertiser name A, the product name B, the product image C, and the target audience D) and input the first prompt P1 into the first generative artificial intelligence model. In this case, the first generative artificial intelligence model, for example, may correspondingly generate the 1st first advertisement creative in the multiple first advertisement creatives, and the 1st advertisement creative may have features/attributes corresponding to the 1st advertisement attribute. For example, if the 1st advertisement attribute is active, then the 1st first advertisement creative may also have the active feature/attribute.

For another example, the processor 104 may generate the corresponding first prompt P2 based on the 2nd input combination (which includes, for example, the advertisement attribute E2, the advertiser name A, the product name B, the product image C, and the target audience D) and input the first prompt P2 into the first generative artificial intelligence model. In this case, for example, the first generative artificial intelligence model may correspondingly generate the 2nd first advertisement creative in the multiple first advertisement creatives, and the 2nd advertisement creative may have features/attributes corresponding to the 2nd advertisement attribute. For example, if the 2nd advertisement attribute is calm, then the 2nd first advertisement creative may also have the calm feature/attribute.

For still another example, the processor 104 may generate the corresponding first prompt P3 based on the 3rd input combination (which includes, for example, the advertisement attribute E3, the advertiser name A, the product name B, the product image C, and the target audience D) and input the first prompt P3 into the first generative artificial intelligence model. In this case, for example, the first generative artificial intelligence model may correspondingly generate the 3rd first advertisement creative in the multiple first advertisement creatives, and the 3rd first advertisement creative may have features/attributes corresponding to the 3rd advertisement attribute. For example, if the 3rd advertisement attribute is bright, then the 3rd advertisement creative may also have the bright feature/attribute.

For the method of generating the other first advertisement creatives by the processor 104, reference may be made to the above description and will not be repeated here.

In an embodiment, the mentioned advertisement creative may be implemented, for example, as a banner advertisement appearing in webpages/apps. Based on this, the behavior of the above embodiment may be understood as generating K banner advertisements respectively corresponding to the K input combinations. In other embodiments, the advertisement creative may also be implemented in other forms, such as an advertisement video or an advertisement audio file, but is not limited thereto.

After generating K first advertisement creatives corresponding to the K input combinations, the processor 104 may deliver the K first advertisement creatives to the target audience D accordingly.

In this way, the target audience D's acceptance of the first advertisement creative with different advertisement attributes (which may be characterized as the advertising performance mentioned later) may be evaluated accordingly, so as to know which advertisement creative with the advertisement attribute should be used in the future to achieve a better advertising performance.

In an embodiment, in step S240, the processor 104 obtains the advertising performance corresponding to each of the first advertisement creatives. In an embodiment, the advertising performance corresponding to each first advertisement creative includes, for example, the click-through rate of each first advertisement creative, but is not limited thereto.

Next, in step S250, the processor 104 determines whether there is a reference advertisement creative whose advertising performance satisfies a preset condition in the first advertisement creative. If not, the processor 104 may return to step S230.

In an embodiment, in response to determining that the click-through rate of one of the first advertisement creatives is higher than a click-through rate threshold, the processor 104 may determine that the advertising performance corresponding to one of the first advertisement creatives satisfies the preset condition and may be determined as the above-mentioned reference advertisement creative.

For example, assuming that the click-through rates of the 1st first advertisement creative to the 3rd first advertisement creative are all determined to be higher than the click-through rate threshold, it means that the 1st first advertisement creative to the 3rd first advertisement creative have a certain appeal to the target audience D. In this case, the processor 104 may correspondingly determine the 1st first advertisement creative to the 3rd first advertisement creative as all the reference advertisement creatives and may continue to perform step S260, but is not limited thereto.

In another embodiment, assuming that the click-through rate of each of the K first advertisement creatives is all lower than the click-through rate threshold, it means that the K first advertisement creatives have less appeal to the target audience D. In this case, the processor 104 may determine that none of the advertising performances corresponding to the first advertisement creatives meets the above-mentioned preset condition and return to step S230 accordingly. In this case, the processor 104 may be understood as generating (new) K first advertisement creatives based on the K input combinations and delivering the (new) K first advertisement creatives to the target audience D again. Afterwards, the processor 104 may continue to perform steps S240 and S250, but is not limited thereto.

In an embodiment, if the processor 104 determines in step S250 that there are reference advertisement creatives whose advertising performances meet the preset condition in the first advertisement creative, it means that the input combination corresponding to the reference advertisement creatives may be used to generate the advertisement creative that meets the preference of the target audience D. In this case, the processor 104 may continue to execute step S260 to find a reference input combination corresponding to the reference advertisement creative from the multiple input combinations. For example, assuming that the 1st first advertisement creative to the 3rd first advertisement creative are all determined to be the reference advertisement creatives meeting the preset condition, the processor 104 may regard the corresponding 1st input combination to the 3rd input combinations as the reference input combinations.

For another example, assuming that the 2nd first advertisement creative, the 4th first advertisement creative, and the 6th first advertisement creative are all determined as the reference advertisement creatives meeting the preset condition, the processor 104 may regard the corresponding 2nd input combination, the 4th input combination, and the 6th input combination as the reference input combinations, but is not limited thereto.

Next, in step S270, the processor 104 generates a corresponding second advertisement creative based on the reference input combination and delivers the second advertisement creative to the target audience D.

In an embodiment, assuming that the number of reference input combinations is M (M is a positive integer), the processor 104 may generate multiple second prompts corresponding to the M reference input combinations and individually input the second prompts into a second generative artificial intelligence model. In different embodiments, the second generative artificial intelligence model may be implemented by selecting different models according to the designer's requirements, such as Midjourney, ChatGPT, but is not limited thereto. In some embodiments, the second generative artificial intelligence model may be the same as or different from the first generative artificial intelligence model.

In an embodiment, the second generative artificial intelligence model may generate second advertisement creatives respectively corresponding to the M reference input combinations in response to the multiple second prompts.

In the embodiment of the disclosure, the processor 104 may generate the corresponding second prompt Qm based on the mth (m is an index) reference input combination and input the second prompt Qm into the second generative artificial intelligence model. In this case, for example, the second generative artificial intelligence model may correspondingly generate the mth second advertisement creative in the multiple second advertisement creatives.

For example, the processor 104 may generate a corresponding second prompt Q1 based on the 1st reference input combination and input the second prompt Q1 into the second generative artificial intelligence model. In this case, for example, the second generative artificial intelligence model may correspondingly generate the 1st second advertisement creative in the multiple second advertisement creatives. Assuming that the 1st reference input combination is the 2nd input combination (which includes, for example, the advertisement attribute E2, the advertiser name A, the product name B, the product image C, and the target audience D), then the 1st second advertisement creative may have features/attributes corresponding to the advertisement attribute E2.

For another example, the processor 104 may generate a corresponding second prompt Q2 based on the 2nd reference input combination and input the second prompt Q2 into the second generative artificial intelligence model. In this case, the second generative artificial intelligence model, for example, may correspondingly generate the 2nd second advertisement creative in the multiple second advertisement creatives. Assuming that the 2nd reference input combination is the 4th input combination (which includes, for example, the advertisement attribute E4, the advertiser name A, the product name B, the product image C, and the target audience D), then the 2nd second advertisement creative may have features/attributes corresponding to the advertisement attribute E4.

For still another example, the processor 104 may generate a corresponding second prompt Q3 based on the 3rd reference input combination and input the second prompt Q3 into the second generative artificial intelligence model. In this case, for example, the second generative artificial intelligence model may correspondingly generate the 3rd second advertisement creative in the multiple second advertisement creatives. Assuming that the 3rd reference input combination is the 6th input combination (which includes, for example, the advertisement attribute E6, the advertiser name A, the product name B, the product image C, and the target audience D), then the 3rd second advertisement creative may have features/attributes corresponding to the advertisement attribute E6.

For the method of generating the other second advertisement creatives by the processor 104, reference may be made to the above description and will not be repeated here.

In other words, after determining that there is a reference advertisement creative that meets the preference of the target audience D, the processor 104 may find out the corresponding input combination as the reference input combination (which includes, for example, the advertisement attributes that meet the preference of the target audience D) and then generate the second advertisement creative. In this way, the second advertisement creative may also have features/attributes that meet the preference of the target audience D and may correspondingly improve the advertising performance.

To sum up, in the embodiment of the disclosure, after the multiple first advertisement creatives are generated based on the input combinations corresponding to the different advertisement attributes, the advertising performance of each first advertisement creative may be determined accordingly. In this way, it may be known which advertisement attribute is more in line with the preference of the target audience.

Afterwards, in the embodiment of the disclosure, the multiple second advertisement creatives may be generated based on the input combination including the advertisement attribute that meet the preference of the target audience and the second advertisement creatives may be delivered to the target audience. In this way, the advertising performance may be correspondingly improved.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure shall be defined in the appended claims.

1. An advertisement delivery method, adapted to an advertisement delivery device, comprising:
obtaining, by the advertisement delivery device, advertisement information and target audience of a specific product, wherein the advertisement information comprises at least one of an advertiser name, a product name, and a product image, and the target audience comprises people having specific interests;
determining, by the advertisement delivery device, K advertisement attributes and determining K input combinations accordingly, wherein each input combination comprises the advertisement information, and the target audience, and one of the K advertisement attributes, wherein K is a positive integer;
generating, by the advertisement delivery device, a plurality of corresponding first advertisement creatives respectively corresponding to the K input combinations based on the K input combinations, comprising:
generating, by the advertisement delivery device, K prompts corresponding to the K input combinations and individually inputting, by the advertisement delivery device, the K prompts into a generative artificial intelligence model, wherein the generative artificial intelligence model outputs the first advertisement creatives respectively corresponding to the K input combinations in response to the K prompts; and
outputting, by the advertisement delivery device, the first advertisement creatives to the target audience;
detecting, by the advertisement delivery device, an advertising performance corresponding to each of the first advertisement creatives;
determining, by the advertisement delivery device, at least one reference input combination corresponding to at least one reference advertisement creative from the K input combinations, in response to determining that the advertising performance corresponding to the at least one reference advertisement creative in the K first advertisement creatives satisfies a preset condition; and
outputting, by the advertisement delivery device, at least one corresponding second advertisement creative based on the at least one reference input combination and outputting the at least one second advertisement creative to the target audience.

2. (canceled)

3. The advertisement delivery method according to claim 1, further comprising:
generating previously presented first advertisement creatives based on the input combination and delivering the previously presented first advertisement creatives to the target audience, in response to determining that the advertising performance corresponding to each of the first advertisement creatives does not meet the preset condition.

4. The advertisement delivery method according to claim 1, wherein the advertising performance corresponding to each of the first advertisement creatives comprises a click-through rate of each of the first advertisement creatives, and the method comprises:
determining that the advertising performance corresponding to one of the first advertisement creatives satisfies the preset condition, in response to determining that the click-through rate of one of the first advertisement creatives is higher than a click-through rate threshold.

5. (canceled)

6. (canceled)

7. (canceled)

8. An advertisement delivery device, comprising:
a storage circuit, wherein the storage circuit stores a program code; and
a processor, coupled to the storage circuit, wherein the processor accesses the program code to:
obtain advertisement information and target audience of a specific product, wherein the advertisement information comprises at least one of an advertiser name, a product name, and a product image, and the target audience comprises people having specific interests;
determine K advertisement attributes and determine K input combinations accordingly, wherein each input combination comprises the advertisement information, the target audience, and one of the advertisement attributes, wherein K is a positive integer;
generate a plurality of corresponding first advertisement creatives respectively corresponding to the K input combinations based on the input combinations, comprising:
generating K prompts corresponding to the K input combinations and individually inputs the K prompts into a generative artificial intelligence model, wherein the generative artificial intelligence model outputs the first advertisement respectively corresponding to the K input combinations in response to the K prompts;
output the first advertisement creatives to the target audience;
detect an advertising performance corresponding to each of the first advertisement creatives;
determine at least one reference input combination corresponding to at least one reference advertisement creative from the K input combinations, in response to determining that the advertising performance corresponding to the at least one reference advertisement creative in the first advertisement creatives satisfies a preset condition; and
output at least one corresponding second advertisement creative based on the at least one reference input combination and output the at least one second advertisement creative to the target audience.

9. (canceled)

10. The advertisement delivery device according to claim 8, wherein the processor further:
generates previously presented first advertisement creatives based on the input combination and delivers the previously presented first advertisement creatives to the target audience, in response to determining that the advertising performance corresponding to each of the first advertisement creatives does not meet the preset condition.

11. The advertisement delivery device according to claim 8, wherein the advertising performance corresponding to each of the first advertisement creatives comprises a click-through rate of each of the first advertisement creatives, and the processor:
determines that the advertising performance corresponding to one of the first advertisement creatives satisfies the preset condition in response to determining that the click-through rate of one of the first advertisement creatives is higher than a click-through rate threshold.

12. (canceled)

13. (canceled)

14. (canceled)
